(19) United States
(12) Patent Application Publication
(10) Pub. No.: US 2010/0178317 A1
(43) Pub. Date: Jul. 15, 2010

(54) Lens Care Solutions with Hyaluronic Acid

(76) Inventors: Susan E. Burke, Batavia, NY (US); Catherine Scheuer, West Henrietta, NY (US); Krista Fridman, Penfield, NY (US); Vicki Barniak, Fairport, NY (US)

Correspondence Address: Bausch & Lomb Incorporated, One Bausch & Lomb Place, Rochester, NY, 14604-2701, US

(21) Appl. No.: 12/684,363

(22) Filed: Jan. 8, 2010

Related U.S. Application Data
(60) Provisional application No. 61/143,461, filed on Jan. 9, 2009.

(51) Int. Cl. A01N 25/34; A01N 43/04; A01P 1/00

(52) U.S. Cl. 424/429; 514/54

(57) ABSTRACT

A method of retaining hyaluronic acid on a surface of a contact lens. The method comprises providing a contact lens care solution comprising;
0.005 wt. % to 0.05 wt. % of hyaluronic acid in a borate containing buffer, and 0.01 wt. % to 1.0 wt. % of an amphoteric surfactant of general formula I

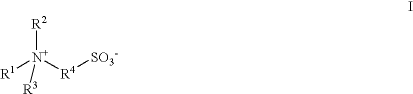

wherein R′ is a C₈-C₁₆alkyl optionally substituted with hydroxyl;
R² and R³ are each independently selected from methyl, ethyl, propyl or iso-propyl; and R⁴ is a C₂-C₈alkylene optionally substituted with hydroxyl; and
soaking the contact lens in the contact lens care solution for at least two hours prior to placement of the contact lens in an eye.

### CROSS-REFERENCE

This application claims the benefit of Provisional Patent Application No. 61/143,461 filed Jan. 9, 2009 which is incorporated by reference herein.

The invention is directed to the use of the ophthalmic compositions that contain hyaluronic acid to clean and disinfect contact lenses.

### BACKGROUND OF THE INVENTION

Presently, there is much interest in improving the comfort profile for those patients that wear contact lenses. Accordingly, considerable efforts are being made to develop new contact lens materials as well as new contact lens care solutions that exhibit an improved comfort profile.

U.S. Pat. No. 5,770,628 by Cantoro describes an ophthalmic, artificial tear composition that contains from 0.05% to 2% by weight hyaluronic acid (sodium hyaluronate). The viscoelastic properties of hyaluronic acid, that is, hard elastic under static conditions though less viscous under small shear forces enables hyaluronic acid to basically function as a shock absorber for ocular cells and tissues. Shortly thereafter, Cantoro, recognized that if one were to add a poloxamer surfactant to the artificial tear, hyaluronic acid formulation the solution could be used as a rewet drop. The poloxamer surfactant is said to clean or remove denatured tear proteins and other containments from extended wear contact lenses while the lenses were being worn. See U.S. Pat. No. 6,528,465.

PCT Application (Publication No. WO 01/057172) describes a contact lens care solution that includes a polysaccharide with a molecular weight of 5000 daltons or greater as a non-enzymatic protein remover (0.005 to 10 wt. %), a nonionic surfactant (0.01 to 10 wt. %) and a polymeric preservative (0.00001 to 1 wt. %). An exemplary solution is provided as Example No. 5. This solution includes 0.02 wt. % sodium hyaluronate, 1.0 wt. % poloxamine (Tetronics® 1107), 0.125 wt. % Na₂EDTA and 1 ppm of PHMB in a phosphate buffer.

Many claims have been made regarding the benefits of using hyaluronic acid in contact lens care solutions to improve the wearing experience of the lens. For example, Park et al. (WO 01/57172) describes multipurpose lens care solutions containing hyaluronic acid to remove protein from the lens. Powell et al. (US 2006/0100173) describes an ophthalmic composition containing hyaluronic acid to provide additional comfort and biocompatibility with lenses. Lang et al. (US 2008/0141628) describes the treatment of packaged contact lenses with hyaluronic acid by the presence of hyaluronic acid in the lens packaging solution. Nakata et al. (JP 11024010) describes the spraying of a solution containing a pharmaceutically active agent and hyaluronic acid onto a contact lens. Nakata goes on to describe the controlled release of the drug and hyaluronic acid from the lens.

### SUMMARY OF THE INVENTION

The invention is directed to a method of retaining hyaluronic acid on a surface of a contact lens. The method comprises providing a contact lens care solution comprising;
0.005 wt. % to 0.05 wt. % of hyaluronic acid in a borate containing buffer, and 0.01 wt. % to 1.0 wt. % of an amphoteric surfactant of general formula I

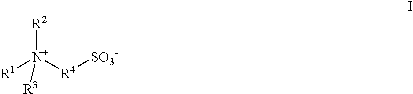

wherein R¹ is a C₈-C₁₆alkyl optionally substituted with hydroxyl;
R² and R³ are each independently selected from methyl, ethyl, propyl or iso-propyl; and R⁴ is a C₂-C₈alkylene optionally substituted with hydroxyl; and

soaking the contact lens in the contact lens care solution for at least two hours prior to placement of the contact lens in an eye.

### BRIEF DESCRIPTION OF THE DRAWINGS

The invention will be better understood from the following description and in consideration with the accompanying figures. It is to be expressly understood, however, that each of the figures is provided to further illustrate and describe the invention and is not intended to further limit the invention claimed.

FIG. 1 is a plot showing the overall results of a clinical comparison between the test solution and control solution for hours of comfortable wear.

FIG. 2 is a plot showing the overall results of a clinical comparison between the test solution and control solution for comfort upon insertion.

FIG. 3 is a plot showing the overall results of a clinical comparison between the test solution and control solution for comfort at end of day.

FIG. 4 is a plot of the hyaluronic acid retention data obtained from a saline drip study for various marketed contact lenses.

FIG. 5A is a comparative plot of the hyaluronic acid retention data obtained from a saline drip study comparing Example 1 vs. Comparative Example 1 with lotrafilcon B contact lens material.

FIG. 5B is a comparative plot of the hyaluronic acid retention data obtained from a saline drip study comparing Example 1 vs. Comparative Example 1 with senofilcon A contact lens material.

FIG. 5C is a comparative plot of the hyaluronic acid retention data obtained from a saline drip study comparing Example 1 vs. Comparative Example 1 with etafilcon A contact lens material.

### DETAILED DESCRIPTION OF THE INVENTION

Applicants and others at Bausch & Lomb have developed and tested numerous ophthalmic formulations for use as lens care solutions. The lens care solutions must satisfy a number of functional characteristics. First, the solutions must possess the cleaning ability to remove denatured tear proteins and tear lipids as well as other external contaminants. Second, the solutions must possess significant disinfecting ability against a number of different bacteria and fungal strains. Third, the solutions must remain comfortable to the contact lens patient with minimal stinging as well as provide a platform to provide additional comfort or protection to the ocular surface. Fourth, the solutions must not cause significant shrinkage or swelling of the many different contact lens materials, which in turn can lead to loss in visual acuity and unwanted or pronounced lens movement.

Applicant's developmental program and their investigations of numerous ophthalmic formulations led to at least three important insights. One, formulations that contain hyaluronic acid tend to provide an improvement in patient comfort than those formulations that do not contain the anionic biopolymer. Two, the anionic sites of the hyaluronic acid appear to interact with the cationic-charged antimicrobial components, and in particular, hyaluronic acid interacts with both PHMB and polyquaternium-1. Three, the presence of the amphoteric surfactant of general formula I appears to counter the interaction between the anionic sites of hyaluronic and the cationic antimicrobial components. The result is a lens care solution that exhibits an exceptional patient comfort profile and biocidal activity.

The amphoteric surfactants of general formula I are surface-active compounds with both acidic and alkaline properties. The amphoteric surfactants of general formula I include a class of compounds known as betaines. The betaines are characterized by a fully quaternized nitrogen atom and do not exhibit anionic properties in alkaline solutions, which means that betaines are present only as zwitterions at near neutral pH.

All betaines are characterized by a fully quaternized nitrogen. In alkyl betaines, one of the alkyl groups of the quaternized nitrogen is an alkyl chain with eight to sixteen carbon atoms. One class of betaines is the sulfobetaines or hydroxysulfobetaines in which the carboxylic group of alkyl betaine is replaced by sulfonate. In hydroxysulfobetaines a hydroxy-group is positioned on one of the alkylene carbons that extend from the quaternized nitrogen to the sulfonate. In alkylamido betaines, an amide group is inserted as a link between the hydrophobic C₈-C₁₆alkyl chain and the quaternized nitrogen.

Accordingly, the invention is directed to ophthalmic compositions comprising: 0.1 ppm to 10 ppm of a cationic antimicrobial component selected from the group consisting of biguanides, polymeric biguanides, quaternium ammonium compounds and any one mixture thereof; 0.005 wt. % to 0.15 wt. % of hyaluronic acid; and 0.01 wt. % to 1.0 wt. % of an amphoteric surfactant of general formula I

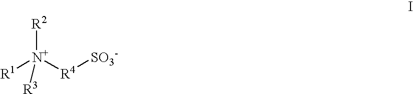

wherein R¹ is a C₈-C₁₆alkyl optionally substituted with hydroxyl; R² and R³ are each independently selected from methyl, ethyl, propyl or iso-propyl; and R⁴ is a C₂-C₈alkylene optionally substituted with hydroxyl.

In one embodiment, the hyaluronic acid is present from 0.002 wt. % to 0.02 wt. %, and the cationic, antimicrobial component is poly(hexamethylene biguanide). Accordingly, one of the more preferred compositions comprises 0.5 ppm to 3.0 ppm of poly(hexamethylene biguanide); 0.002 wt. % to 0.02 wt. % hyaluronic acid; and 0.01 wt. % to 1 wt. % of an amphoteric surfactant of general formula I.

Certain sulfobetaines of general formula I are more preferred than others. For example, Zwitergent®3-10 available from Calbiochem Company, is a sulfobetaine of general formula I wherein R′ is a straight, saturated alkyl with ten (10) carbons, R² and R³ are each methyl and R⁴ is —CH₂CH₂CH₂— (three carbons, (3)). Other sulfobetaines that can be used in the ophthalmic compositions include the corresponding Zwitergent®3-08 (R¹ is a is a straight, saturated alkyl with eight carbons), Zwitergent®3-12 (R¹ is a is a straight, saturated alkyl with twelve carbons), Zwitergent® 3-14 (R¹ is a is a straight, saturated alkyl with fourteen carbons) and Zwitergent®3-16 (R¹ is a is a straight, saturated alkyl with sixteen carbons). Accordingly, some of the more preferred the ophthalmic composition will include a sulfobetaine of general formula II wherein R¹ is a C₈-C₁₆alkyl and R² and R³ is methyl.

Hyaluronic acid is a linear polysaccharide (long-chain biological polymer) formed by repeating disaccharide units consisting of D-glucuronic acid and N-acetyl-D-glucosamine linked by β(1-3) and β(1-4) glycosidic linkages. Hyaluronic acid is distinguished from the other glycosaminoglycans, as it is free from covalent links to protein and sulphonic groups. Hyaluronic acid is ubiquitous in animals, with the highest concentration found in soft connective tissue. It plays an important role for both mechanical and transport purposes in the body; e.g., it gives elasticity to the joints and rigidity to the vertebrate disks, and it is also an important component of the vitreous body of the eye.

Hyaluronic acid is accepted by the ophthalmic community as a compound that can protect biological tissues or cells from compressive forces. Accordingly, hyaluronic acid has been proposed as one component of a viscoelastic ophthalmic composition for cataract surgery. The viscoelastic properties of hyaluronic acid, that is, hard elastic under static conditions though less viscous under small shear forces enables hyaluronic acid to basically function as a shock absorber for cells and tissues. Hyaluronic acid also has a relatively large capacity to absorb and hold water. The stated properties of hyaluronic acid are dependent on the molecular weight, the solution concentration, and physiological pH. At low concentrations, the individual chains entangle and form a continuous network in solution, which gives the system interesting properties, such as pronounced viscoelasticity and pseudoplasticity that is unique for a water-soluble polymer at low concentration.

As stated, the compositions will also include an antimicrobial component selected from quarternary ammonium compounds (including small molecules) and polymers and low and high molecular weight biguanides. For example, biguanides include the free bases or salts of alexidine, chlorhexidine, hexamethylene biguanides and their polymers, and combinations thereof. The salts of alexidine and chlorhexidine can be either organic or inorganic and include gluconates, nitrates, acetates, phosphates, sulfates, halides and the like.

In a preferred embodiment, the composition will include a polymeric biguanide known as poly(hexamethylene biguanide) (PHMB or PAPB) commercially available from Zeneca, Wilmington, Del. under the trademark Cosmocil™ CQ. The PHMB is present in the compositions from 0.2 ppm to 5 ppm or from 0.5 ppm to 2 ppm.

Another biguanide of interest is 1,1′-hexamethylene-bis[5-(2-ethylhexyl)biguanide], which is referred to in the art as “alexidine”. The alexidine is present in the compositions from 0.5 ppm to 5 ppm or from 0.5 ppm to 2 ppm.

One of the more common quaternary ammonium compounds is α-[4-tris(2-hydroxyethyl)-ammonium chloride-2-butenyl]poly[1-dimethyl ammonium chloride-2-butenyl]-ω-tris(2-hydroxyethyl) ammonium chloride, also referred to in the art as polyquaternium-1. Quaternary ammonium compounds are generally referred to in the art as “polyquatemium” disinfectants, and are identified by a particular number following the designation such as polyquaternium-1, polyquaternium-10 or polyquaternium-42. Polyquaternium-1 is present in the ophthalmic compositions from 0.5 ppm to 3 ppm. Attempts to increase the concentration of polyquaternium-1 beyond 3 ppm in the compositions results in the formation of a precipitate. The precipitate is believed to be the complexation product of hyaluronic acid and polyquaternium-1.

Polyquaternium-42 is also one of the more preferred polyquaternium disinfectants, see, U.S. Pat. No. 5,300,296. Polyquaternium-42 is present in the ophthalmic compositions from 5 ppm to 50 ppm.

It is to be understood by those in the art that the compositions can include one or more of the antimicrobial components described above. For example, in one embodiment, the ophthalmic compositions include polyquaternium-1 in combination with a biguanide antimicrobial component such as poly(hexamethylene biguanide). The polyquaternium-1 is present in relatively low concentrations, that is, from 0.5 ppm to 3 ppm, relative to the reported concentration of polyquaternium-1 in both Opti-Free®Express and Opti-Free®Replenish. Applicants believe that the polyquaternium-1 and the PHMB, in combination, may enhance the biocidal efficacy of the ophthalmic compositions.

### Contact Lens Care Compositions

The contact lens care solutions will very likely include a buffer system. By the terms “buffer” or “buffer system” is meant a compound that, usually in combination with at least one other compound, provides a buffering system in solution that exhibits buffering capacity, that is, the capacity to neutralize, within limits, either acids or bases (alkali) with relatively little or no change in the original pH. Generally, the buffering components are present from 0.05% to 2.5% (w/v) or from 0.1% to 1.5% (w/v).

The term “buffering capacity” is defined to mean the millimoles (mM) of strong acid or base (or respectively, hydrogen or hydroxide ions) required to change the pH by one unit when added to one liter (a standard unit) of the buffer solution. The buffer capacity will depend on the type and concentration of the buffer components. The buffer capacity is measured from a starting pH of 6 to 8, preferably from 7.4 to 8.4.

Borate buffers include, for example, boric acid and its salts, for example, sodium borate or potassium borate. Borate buffers also include compounds such as potassium tetraborate or potassium metaborate that produce borate acid or its salt in solutions. Borate buffers are known for enhancing the efficacy of certain polymeric biguanides. For example, U.S. Pat. No. 4,758,595 to Ogunbiyi et al. describes that a contact-lens solution containing PHMB can exhibit enhanced efficacy if combined with a borate buffer.

A phosphate buffer system preferably includes one or more monobasic phosphates, dibasic phosphates and the like. Particularly useful phosphate buffers are those selected from phosphate salts of alkali and/or alkaline earth metals. Examples of suitable phosphate buffers include one or more of sodium dibasic phosphate (Na₂HPO₄), sodium monobasic phosphate (NaH₂PO₄) and potassium monobasic phosphate (KH₂PO₄). The phosphate buffer components frequently are used in amounts from 0.01% or to 0.5% (w/v), calculated as phosphate ion.

Other known buffer compounds can optionally be added to the lens care compositions, for example, citrates, citric acid, sodium bicarbonate, TRIS, and the like. Other ingredients in the solution, while having other functions, may also affect the buffer capacity, e.g., propylene glycol or glycerin.

A preferred buffer system is based upon boric acid/borate, a mono and/or dibasic phosphate salt/phosphoric acid or a combined boric/phosphate buffer system. For example a combined boric/phosphate buffer system can be formulated from a mixture of boric acid/sodium borate and a monobasic/dibasic phosphate. In a combined boric/phosphate buffer system, the phosphate buffer is used (in total) at a concentration of 0.004 to 0.2 M (Molar), preferably 0.04 to 0.1 M. The borate buffer (in total) is used at a concentration of 0.02 to 0.8 M, preferably 0.07 to 0.2 M.

The lens care solutions can also include an effective amount of a surfactant component, in addition to the amphoteric surfactant of general formula I, a viscosity inducing or thickening component, a chelating or sequestering component, or a tonicity component. The additional component or components can be selected from materials which are known to be useful in contact lens care solutions and are included in amounts effective to provide the desired functional characteristic.

Suitable surfactants can be cationic or nonionic, and are typically present (individually or in combination) in amounts up to 2% w/v. One preferred surfactant class are the nonionic surfactants. The surfactant should be soluble in the lens care solution and non-irritating to eye tissues. Many nonionic surfactants comprise one or more chains or polymeric components having oxyalkylene (—O—R—) repeats units wherein R has 2 to 6 carbon atoms. Preferred non-ionic surfactants comprise block polymers of two or more different kinds of oxyalkylene repeat units, which ratio of different repeat units determines the HLB of the surfactant. Satisfactory non-ionic surfactants include polyethylene glycol esters of fatty acids, e.g. coconut, polysorbate, polyoxyethylene or polyoxypropylene ethers of higher alkanes (C₁₂-C₁₈). Examples of this class include polysorbate 20 (available under the trademark Tween® 20), polyoxyethylene (23) lauryl ether (Brij® 35), polyoxyethyene (40) stearate (Myrj®52), polyoxyethylene (25) propylene glycol stearate (Atlas® G 2612). Still another preferred surfactant is tyloxapol.

A particular non-ionic surfactant consisting of a poly(oxypropylene)-poly(oxyethylene) adduct of ethylene diamine having a molecular weight from about 6,000 to about 24,000 daltons wherein at least 40 weight percent of said adduct is poly(oxyethylene) has been found to be particularly advantageous for use in cleaning and conditioning both soft and hard contact lenses. The CTFA Cosmetic Ingredient Dictionary's adopted name for this group of surfactants is poloxamine. Such surfactants are available from BASF Wyandotte Corp., Wyandotte, Mich., under Tetronic®. Particularly good results are obtained with poloxamine 1107 or poloxamine 1304. The foregoing poly(oxyethylene) poly(oxypropylene) block polymer surfactants will generally be present in a total amount from 0.0 to 2% w/v, from 0. to 1% w/v, or from 0.2 to 0.8% w/v.

An analogous of series of surfactants, for use in the lens care compositions, is the poloxamer series which is a poly(oxyethylene) poly(oxypropylene) block polymers available under Pluronic® (commercially available form BASF). In accordance with one embodiment of a lens care composition the poly(oxyethylene)-poly(oxypropylene) block copolymers will have molecular weights from 2500 to 13,000 daltons or from 6000 to about 12,000 daltons. Specific examples of surfactants which are satisfactory include: poloxamer 108, poloxamer 188, poloxamer 237, poloxamer 238, poloxamer 288 and poloxamer 407. Particularly good results are obtained with poloxamer 237 or poloxamer 407. The foregoing poly(oxyethylene) poly(oxypropylene) block polymer surfactants will generally be present in a total amount from 0.0 to 2% w/v, from 0. to 1% w/v, or from 0.2 to 0.8% w/v.

The lens care solutions can also include a phosphonic acid, or its physiologically compatible salt, that is represented by the following formula:

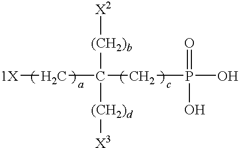

wherein each of a, b, c, and d are independently selected from integers from 0 to 4, preferably 0 or 1; X¹ is a phosphonic acid group (i.e., P(OH)₂O), hydroxy, amine or hydrogen; and X² and X³ are independently selected from the group consisting of halogen, hydroxy, amine, carboxy, alkylcarbonyl, alkoxycarbonyl, or substituted or unsubstituted phenyl, and methyl. Exemplary substituents on the phenyl are halogen, hydroxy, amine, carboxy and/or alkyl groups. A particularly preferred species is that wherein a, b, c, and d in are zero, specifically the tetrasodium salt of 1-hydroxyethylidene-1,1-diphosphonic acid, also referred to as tetrasodium etidronate, commercially available from Monsanto Company as DeQuest® 2016 diphosphonic acid sodium salt or phosphonate.

The lens care solutions can include dexpanthenol, which is an alcohol of pantothenic acid, also called Provitamin B5, D-pantothenyl alcohol or D-panthenol. It has been stated that dexpanthenol may play a role in stabilizing the lachrymal film at the eye surface following placement of a contact lens on the eye. Dexpanthenol is preferably present in the solution in an amount from 0.2 to 5%/v, from 0.5 to 3% w/v, or from 1 to 2% w/v.

The contact lens care solutions can also include a sugar alcohol such as sorbitol or xylitol. Typically, dexpanthenol is used in combination with the sugar alcohol. The sugar alcohol is present in the lens care compositions in an amount from 0.4 to 5% w/v or from 0.8 to 3% w/v.

The lens care solutions can also include one or more neutral or basic amino acids. The neutral amino acids include: the alkyl-group-containing amino acids such as alanine, isoleucine, valine, leucine and proline; hydroxyl-group-containing amino acids such as serine, threonine and 4-hydroxyproline; thio-group-containing amino acids such as cysteine, methionine and asparagine. Examples of the basic amino acid include lysine, histidine and arginine. The one or more neutral or basic amino acids are present in the compositions at a total concentration of from 0.1 to 3% w/v.

The lens care solutions can also include glycolic acid, asparatic acid or any mixture of the two at a total concentration of from 0.001% to 4% (w/v) or from 0.01% to 2.0% (w/v). In addition, the combined use of one or more amino acids and glycolic acid and/or asparatic acid can lead to a reduction in the change of the size of the contact lens due to swelling and shrinkage following placement in the lens solution.

The lens care solutions can also include one or more comfort or cushioning components, in addition to the hyaluronic acid. The comfort component can enhance and/or prolong the cleaning and wetting activity of the surfactant component and/or condition the lens surface rendering it more hydrophilic (less lipophilic) and/or to act as a demulcent on the eye. The comfort component is believed to cushion the impact on the eye surface during placement of the lens and serves also to alleviate eye irritation.

Suitable comfort components include, but are not limited to, water soluble natural gums, cellulose-derived polymers and the like. Useful natural gums include guar gum, gum tragacanth and the like. Useful cellulose-derived comfort components include cellulose-derived polymers, such as hydroxypropyl cellulose, hydroxypropylmethyl cellulose, carboxymethyl cellulose, methyl cellulose, hydroxyethyl cellulose and the like. A very useful comfort component is hydroxypropylmethyl cellulose (HPMC). Some non-cellulose comfort components include propylene glycol or glycerin. The comfort components are typically present in the solution from 0.01% to 1% (w/v).

One preferred comfort agent that is believed to maintain a hydrated corneal surface is polyvinylpyrrolidone (PVP). PVP is a linear homopolymer or essentially a linear homopolymer comprising at least 90% repeat units derived from 1-vinyl-2-pyrrolidone monomer, the remainder of the monomer composition can include neutral monomer, e.g., vinyl or acrylates. Other synonyms for PVP include povidone, polyvidone, 1-vinyl-2-pyrrolidinone, and 1-ethenyl-2-pyrolionone (CAS registry number 9003-39-8). The PVP will preferably have a weight average molecular weight from 10,000 to 250,000 or from 30,000 to 100,000. Such materials are sold by various companies, including ISP Technologies, Inc. under the trademark PLASDONE®K-29/32, from BASF under the trademark KOLLIDON®, for example, KOLLIDON® K-30 or K-90. It is also preferred that one use pharmaceutical grade PVP.

The lens care solutions can also include one or more chelating components to assist in the removal of lipid and protein deposits from the lens surface following daily use. Typically, the ophthalmic compositions will include relatively low amounts, e.g., from 0.005% to 0.05% (w/v) of ethylenediaminetetraacetic acid (EDTA) or the corresponding metal salts thereof such as the disodium salt, Na₂EDTA.

One possible alternative to the chelator Na₂EDTA or a possible combination with Na₂EDTA, is a disuccinate of formula IV below or a corresponding salt thereof;

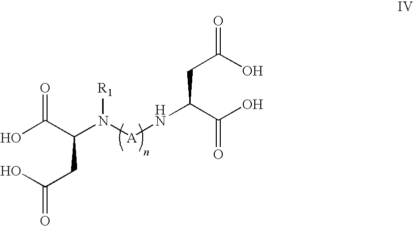

wherein R₁ is selected from hydrogen, alkyl or —C(O)alkyl, the alkyl having one to twelve carbons and optionally one or more oxygen atoms, A is a methylene group or an oxyalkylene group, and n is from 2 to 8. In one embodiment, the disuccinate is S,S-ethylenediamine disuccinate (S,S-EDDS) or a corresponding salt thereof. One commercial source of S,S-EDDS is represented by Octaquest® E30, which is commercially available from Octel. The chemical structure of the trisodium salt of S,S-EDDS is shown below. The salts can also include the alkaline earth metals such as calcium or magnesium. The zinc or silver salt of the disuccinate can also be used in the ophthalmic compositions.

Still another class of chelators include alkyl ethylenediaminetriacetates such as nonayl ethylenediaminetriacetate. See, U.S. Pat. No. 6,995,123 for a more complete description of such agents.

The lens care solutions will typically include an effective amount of a tonicity adjusting component. Among the suitable tonicity adjusting components that can be used are those conventionally used in contact lens care products such as various inorganic salts. Sodium chloride and/or potassium chloride and the like are very useful tonicity components. The amount of tonicity adjusting component is effective to provide the desired degree of tonicity to the solution.

The lens care solutions will typically have an osmolality in the range of at least about 200 mOsmol/kg for example, about 300 or about 350 to about 400 mOsmol/kg. The lens care solutions are substantially isotonic or hypertonic (for example, slightly hypertonic) and are ophthalmically acceptable.

One exemplary ophthalmic composition is formulated as a contact lens disinfecting solution prepared with the components and amounts of each listed in Table 1.

TABLE 1

| | | | Preferred |
|---|---|---|---|
| | Minimum | Maximum | Amount |
| Component | Amount (wt. %) | Amount (wt. %) | (wt. %) |
| boric acid | 0.10 | 1.0 | 0.64 |
| sodium borate | 0.01 | 0.20 | 0.1 |
| sodium chloride | 0.20 | 0.80 | 0.49 |
| Zwitergent ® 3-10 | 0.005 | 0.80 | 0.1 |
| hyaluronic acid | 0.005 | 0.05 | 0.01 |
| Tetronic ® 1107 | 0.05 | 2.0 | 1.00 |
| Na₂EDTA | 0.005 | 0.15 | 0.03 |
| PHMB | 0.2 ppm | 2 ppm | 1.3 ppm |
| polyquaternium-1 | 0.5 ppm | 5 ppm | 1 ppm |

Another contact lens solution includes the following ingredients listed in Table 2.

TABLE 2

| | | | Preferred |
|---|---|---|---|
| | Minimum | Maximum | Amount |
| Component | Amount (wt. %) | Amount (wt. %) | (wt. %) |
| sorbitol or xylitol | 0.5 | 5 | 3 |
| poloxamer 407 | 0.05 | 1.0 | 0.10 |
| sodium phosphate, | 0.10 | 0.8 | 0.46 |
| dihydrogen | | | |
| Dexpanthenol | 0.01 | 1.0 | 0.03 |
| zwitergent ® 3-10 | 0.01 | 0.2 | 0.05 |
| hyaluronic acid | 0.005 | 0.03 | 0.01 |
| Na₂EDTA | 0.005 | 0.3 | 0.1 |
| PHMB | 0.2 ppm | 2 ppm | 1 ppm |

Other contact lens solutions according includes the following ingredients listed in Tables 3 to 5.

TABLE 3

| | | | Preferred |
|---|---|---|---|
| | Minimum | Maximum | Amount |
| Component | Amount (wt. %) | Amount (wt. %) | (wt. %) |
| NaCl/KCl | 0.2 | 1.0 | 0.50 |
| propylene glycol | 0.1 | 1.0 | 0.50 |
| poloxamer 237 | 0.01 | 0.20 | 0.05 |
| phosphate monobasic | 0.05 | 0.40 | 0.10 |
| phosphate dibasic | 0.05 | 0.4 | 0.12 |
| zwitergent ® 3-10 | 0.01 | 0.3 | 0.1 |
| hyaluronic acid | 0.005 | 0.02 | 0.008 |
| Na₂EDTA | 0.005 | 0.3 | 0.1 |
| PHMB | 0.2 ppm | 2 ppm | 1.1 ppm |
| polyquaternium-1 | 0.5 ppm | 3 ppm | 1 ppm |

TABLE 4

| | | | Preferred |
|---|---|---|---|
| | Minimum | Maximum | Amount |
| Component | Amount (wt. %) | Amount (wt. %) | (wt. %) |
| NaCl/KCl | 0.01 | 0.5 | 0.10 |
| Sorbitol | 0.2 | 2.0 | 0.5 |
| Propylene glycol | 0.2 | 2.0 | 0.6 |
| Poloxamine 1304 | 0.01 | 0.2 | 0.05 |
| Boric acid | 0.1 | 1.0 | 0.60 |
| Sodium borate | 0.01 | 0.2 | 0.10 |
| Hydroxypropyl guar | 0.01 | 0.5 | 0.05 |
| zwitergent ® 3-10 | 0.01 | 0.2 | 0.05 |
| hyaluronic acid | 0.005 | 0.03 | 0.01 |
| Na₂EDTA | 0.02 | 0.1 | 0.05 |
| PHMB | 0.2 ppm | 2 ppm | 0.3 ppm |
| polyquaternium-1 | 0.5 ppm | 3 ppm | 1.5 ppm |

TABLE 5

| | | | Preferred |
|---|---|---|---|
| | Minimum | Maximum | Amount |
| Component | Amount (wt. %) | Amount (wt. %) | (wt. %) |
| NaCl/KCl | 0.05 | 0.5 | 0.10 |
| phosphate monobasic | 0.05 | 0.40 | 0.12 |
| phosphate dibasic | 0.05 | 0.4 | 0.21 |
| Sorbitol | 0.5 | 2.0 | 1.0 |
| Poloxamine 904 | 0.02 | 0.5 | 0.10 |
| Povidone K90 | 0.05 | 0.5 | 0.10 |
| zwitergent ® 3-10 | 0.01 | 0.2 | 0.05 |
| hyaluronic acid | 0.005 | 0.03 | 0.01 |
| Na₂EDTA | 0.005 | 0.3 | 0.1 |
| PHMB | 0.2 ppm | 2 ppm | 1 ppm |
| polyquaternium-1 | 0.5 ppm | 3 ppm | 1.5 ppm |

As described, the ophthalmic compositions can be used to clean and disinfect contact lenses. In general, the contact lens solutions can be used as a daily or every other day care regimen known in the art as a “no-rub” regimen. This procedure includes removing the contact lens from the eye, rinsing both sides of the lens with a few milliliters of solution and placing the lens in a lens storage case. The lens is then immersed in fresh solution for at least two hours. The lens is the removed form the case, optionally rinsed with more solution, and repositioned on the eye.

Alternatively, a rub protocol would include each of the above steps plus the step of adding a few drops of the solution to each side of the lens, followed by gently rubbing the surface between ones fingers for approximately 3 to 10 seconds. The lens can then be, optionally rinsed, and subsequently immersed in the solution for at least two hours. The lenses are removed from the lens storage case and repositioned on the eye.

The ophthalmic compositions can be used with many different types of contact lenses including: (1) hard lenses formed from materials prepared by polymerization of acrylic esters, such as poly(methyl methacrylate) (PMMA), (2) rigid gas permeable (RGP) lenses formed from silicone acrylates and fluorosilicone methacrylates, (3) soft, hydrogel lenses, and (4) non-hydrogel elastomer lenses.

As an example, soft hydrogel contact lenses are made of a hydrogel polymeric material, a hydrogel being defined as a crosslinked polymeric system containing water in an equilibrium state. In general, hydrogels exhibit excellent biocompatibility properties, i.e., the property of being biologically or biochemically compatible by not producing a toxic, injurious or immunological response in a living tissue. Representative conventional hydrogel contact lens materials are made by polymerizing a monomer mixture comprising at least one hydrophilic monomer, such as (meth)acrylic acid, 2-hydroxyethyl methacrylate (HEMA), glyceryl methacrylate, N,N-dimethacrylamide, and N-vinylpyrrolidone (NVP). In the case of silicone hydrogels, the monomer mixture from which the copolymer is prepared further includes a silicone-containing monomer, in addition to the hydrophilic monomer. Generally, the monomer mixture will also include a crosslink monomer such as ethylene glycol dimethacrylate, tetraethylene glycol dimethacrylate, and methacryloxyethyl vinylcarbonate. Alternatively, either the silicone-containing monomer or the hydrophilic monomer may function as a crosslink agent.

The ophthalmic compositions can also be formulated as a contact lens rewetting eye drop solution. By way of example, the rewetting drops may be formulated according to any one of the foregoing formulations of Tables 1 to 5 above. Alternatively, the formulations may be modified by increasing the amount of surfactant; by reducing the amount of antimicrobial agent to a preservative amount and/or by adding a humectant and/or demulcent.

The ophthalmic compositions can be used as a preservative in formulations for treating patients with dry eye. In such a method, the ophthalmic composition is administered to the patient's eye, eye lid or to the skin surrounding the patient's eye. The compositions can be administered to the eyes irrespective of whether contact lenses are present in the eyes of the patient. For example, many people suffer from temporary or chronic eye conditions in which the eye's tear system fails to provide adequate tear volume or tear film stability necessary to remove irritating environmental contaminants such as dust, pollen, or the like.

The ophthalmic compositions can also be used as a preservative in pharmaceutical compositions such as nasal sprays, ear and eye drops, suppositories, and prescription and over-the-counter formulations containing a pharmaceutical active that are used or administered over time such as a cream, ointment, gel or solution.

In many instances, the ophthalmic compositions will include one or more active pharmaceutical agents. Generally, the active pharmaceutical agent is in one or more classes of ocular pharmaceuticals including, but not limited to anti-inflammatory agents, antibiotics, immunosuppressive agents, antiviral agents, antifungal agents, anesthetics and pain killers, anticancer agents, anti-glaucoma agents, peptide and proteins, anti-allergy agents.

### EXAMPLES

### Examples 1

A contact lens compositions of Example 1 listed in Table 6 is prepared using the following process (components are listed in wt. % unless noted in ppm). A volume of purified water equivalent to 85-90% of the total batch weight is added to a stainless steel mixing vessel. The following batch quantities of components are added to the water with stirring in the order listed: sodium chloride, edetate disodium, boric acid, sodium borate and poloxamine 1107. The solution is mixed (stirred) for not less than 10 minutes to ensure complete dissolution of each of the components. The solution is warmed to a temperature not less than 70° C. and the sodium hyaluronate is added. The warmed solution is stirred for at least 20 minutes until the sodium hyaluronate appears to be completely dissolved. The pH of the resulting solution is measured at room temperature, and if necessary, the pH is adjusted with 1N NaOH or 1N HCl (target pH=7.5). The solution is then heat sterilized at 121° C. for at least 30 minutes.

TABLE 6

| | Example |
|---|---|
| | 1 |
| boric acid | 0.64 |
| sodium borate | 0.105 |
| sodium chloride | 0.50 |
| Na₂EDTA | 0.025 |
| Tetronics ® 1107 | 1.0 |
| sodium hyaluronate | 0.01 |
| Zwitergent ® 3-10 | 0.05 |
| PAPB (ppm) | 1.3 |
| polyquaternium-1 (ppm) | 1.0 |

In a second stainless steel vessel, a measured amount of Zwittergent 3-10 required for the batch is added to a given amount of purified water, and the solution stirred for at least 30 minutes. The Zwittergent solution is aseptically transferred to the bulk solution through a sterilizing filter, and again the solution is stirred for at least 10 minutes.

In a third stainless steel vessel, a measured amount of PAPB required for the batch is added to a given amount of purified water, and the solution is stirred for at least 10 minutes. The PAPB solution is aseptically transferred to the bulk solution through a sterilizing filter, and again the solution is stirred for at least 10 minutes.

In a fourth stainless steel vessel, a measured amount of polyquaternium-1 required for the batch is added to a given amount of purified water, and the solution is stirred for at least 10 minutes. The polyquaternium-1 solution is aseptically transferred to the bulk solution through a sterilizing filter, and again the solution is stirred for at least 10 minutes. Purified water is then added to the bulk solution to bring to the batch weight. The final solution is stirred for at least 15 minutes.

Clinical Evaluation of Example 5 vs. Opti-Free®Replenish

A multi-center, masked, active-controlled, bilateral, parallel-group, two-week study was conducted with half of the subjects randomized to receive the lens care solution of Example 5 (test solution) and half to receive Opti-Free®Replenish (control solution) lens care solution. All subjects were dispensed a new pair of their habitual lenses (⅓ PureVision®, ⅓ Acuvue®Oasys, and ⅓ Night&Day® or O₂Optix®) and either the test or control lens care solution at the beginning of the study. The subjects were instructed to the use of the solutions and care of their lenses. Subjects were also required to complete a daily diary for the first week of the study and mail the completed study to their respective sponsor. The study included 361 subjects (347 completed studies) of Asian descent with the demographics reported in Table 7.

TABLE 7
Clinical Demographics

| demographic | test | control |
|---|---|---|
| age, n | 175 | 175 |
| mean (sd) | 28.3 (7.4) | 27.4 (7.3) |
| min. max | 18, 54 | 18, 48 |
| gender n (%) | | |
| female | 125 (71.4) | 124 (69.1) |
| male | 50 (28.6) | 54 (30.9) |
| daily wear time | | |
| mean (sd) | 11.9 (2.7) | 11.6 (2.6) |
| min. max | 6, 24 | 5, 24 |
| refraction sphere | | |
| (diopters), mean | −3.79 (1.86) | −3.96 (2.05) |
| min, max | −10.75, −0.50 | −10.25, 0.75 |
| refraction cylinder | | |
| (diopters), mean | −0.353 (0.36) | −0.40, (0.4) |
| min, max | −1.5, 0.0 | −1.75, 0.0 |

### Study Results

Subjects rated their subjective symptoms/complaints using a 0 to 100 scale for each eye. Zero represented the least favorable rating for several lens care characteristics (e.g., end of day comfort, burning/stinging upon insertion of lenses, irritation and dryness) and a 100 represented the most favorable rating. At the two-week follow-up visit, the test solution of Ex. 5 was not statistically significantly different from the control solution for any symptom/complaint. The test solution demonstrated that it was at least as good as the control solution during the first seven days of product use for all diary-lens performance ratings.

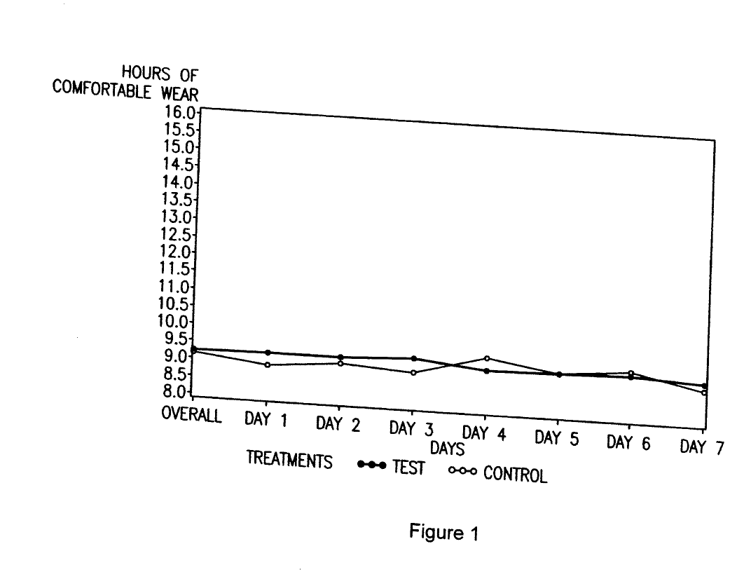

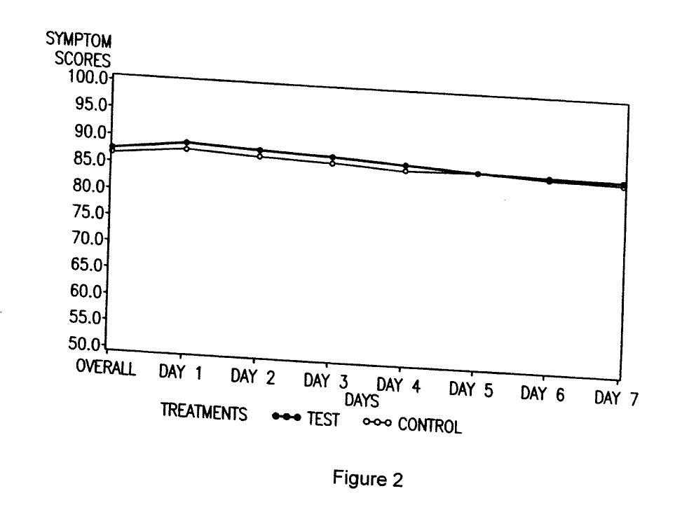

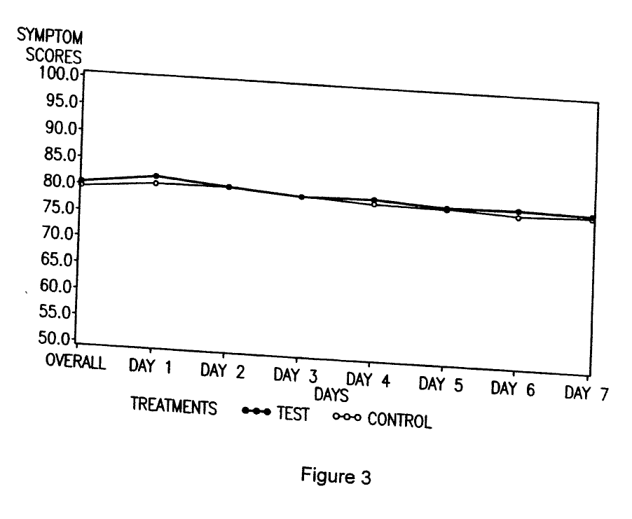

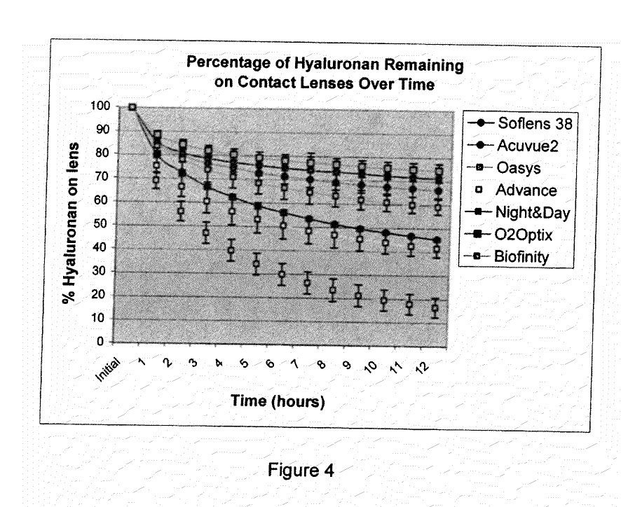

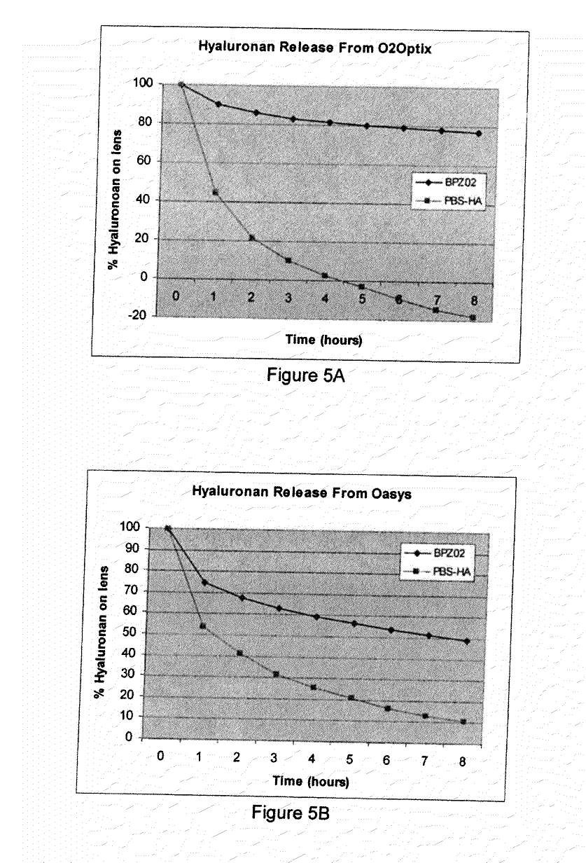

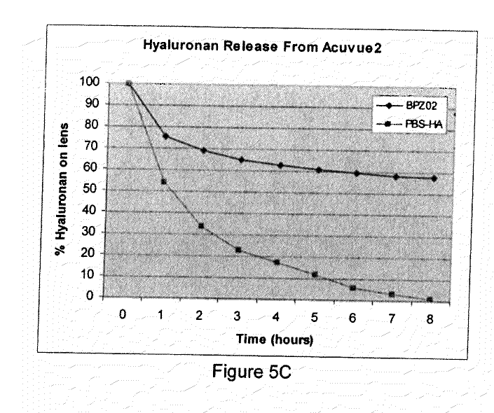

The overall results for all subjects irrespective of lens type are represented by line plots. FIG. 1 shows the results of a clinical comparison between the test solution and control solution for hours of comfortable wear. FIG. 2 shows the results between the test solution and control solution for cleanliness of lens at insertion. FIG. 3 shows the results between the test solution and control solution for comfort upon insertion. FIG. 4 shows the results between the test solution and control solution for cleanliness of lens at end of day. FIG. 5 shows the results between the test solution and control solution for comfort at end of day.

### Dry Eye Results

Sixteen (16) subjects were identified with having dry eye related symptoms for each of the test solution and control solution. Dry eye is defined as an eye at the baseline visit who responded that their eye “often” or “constantly” felt dry and irritated or was ever diagnosed by a physician as having dry eye syndrome. The preliminary results listed in Table 8 suggest that the test solution outperformed the control solution in subjects with dry eye symptoms. For each diary question, scores are compared between the test solution and the control solution using a longitudinal analysis. A score of zero represents a most unfavorable rating and a score of 100 represents a most favorable rating.

TABLE 8

| Performance Criteria | mean (sd) | mean (sd) |
|---|---|---|
| comfort upon insertion | | |
| day 1 | 85 (33) | 75 (33) |
| day 7 | 88 (31) | 71 (33) |
| cleanliness (end of day) | | |
| day 1 | 77 (37) | 61 (37) |
| day 7 | 76 (35) | 61 (37) |
| comfort (end of day) | | |
| day 1 | 73 (35) | 58 (35) |
| day 7 | 74 (33) | 59 (35) |

### Saline Dip Investigation

Calibration standards for the investigation were made by serial dilution of the multi-purpose solution of Example 1 which was prepared with fluorescein-tagged hyaluronic acid available from Sigma-Aldrich F1177 in HBSS to the appropriate concentrations (10, 1, 0.1, 0.01, and 0.001 ppm) of fluorescein-tagged HA.

For each of the experiments conducted, the lenses were rinsed with phosphate buffered saline (PBS) and allowed to soak overnight in the PBS. The lenses were then lightly touched to a laboratory tissue to remove any excess PBS before placing in a Bausch & Lomb Leak Proof lens case with 3 mL of Example 1 prepared with fluorescein-tagged hyaluronic acid. Each of the lenses were then soaked overnight in the tagged Example 1 lens care solution. The following morning, the lenses were removed from their lens cases using tweezers, lightly touched to a laboratory tissue, and placed in a modified hydrogen peroxide lens case equipped with a basket holder to hold a lens.

The modified peroxide lens case includes a small hole positioned in a side of the case. The hole is positioned directly over the center of the lens basket holder that contained a soaked lens. A piece of small diameter tubing from a syringe pump was passed through the hole. After the caps of the lens cases were attached, adjustments were made to center the opening of the tubing over each lens. The pumps delivered HBSS to the lenses at a rate of 3.8 μL/min. The rinse solutions were collected from the cases every hour or so for a total of twelve hours. The collected rinse solutions were transferred to 96-well dilution plate and kept out of direct light until fluorescence detection. After completion of all rinse collections, 150 μL of each solution from time points 2 hours through 12 hours was transferred to 96-well MicroFluor-1 plate. Dilutions were prepared 1:10 from the 1 hour rinse collections from fluorescein-tagged HA solution, 150 μl of which was transferred to MicroFluor-1 wells.

The studies were performed using four lenses of each type listed in Table 9; three lenses were soaked in the tagged Example 1 solution and the other was soaked in Example 1 solution (non-tagged hyaluronic acid).

Standard Curve: Serial dilutions of fluorescein-tagged HA solution were prepared in MicroFluor-1 plates to create a series of four dilutions at 1:10, 1:100, 1:1000, and 1:10000 equivalent to 10 ppm, 1.0 ppm, 0.1 ppm and 0.01 ppm fluorescein-tagged HA, respectively.

Fluorescence Detection: The fluorescence intensity of the rinse solutions (the solutions collected from the modified lens case as the HBSS drips onto the lens) and the standards were detected in volumes of 150 μl in wells of a MicroFluor-1 plate. The plates were read in a Bio-Tek FLx800 Microplate Fluorescence Reader; excitation wavelength was 485 nm and emission wavelength was 528 nm; sensitivity was 80.

Conditioning Agent Release Analysis: Fluorescence background of HBSS wells was subtracted from fluorescence intensities measured for each sample. Lens specific background was subtracted from the fluorescence intensities measured for each lens type.

Standard curves for obtaining fluorescein-tagged hyaluronic acid concentration from fluorescence intensity measurements were generated by plotting the fluorescence intensity of fluorescein-tagged HA solution versus the known concentration of the hyaluronic acid for each dilution prepared. Linear regression was applied in Microsoft Excel and an equation was generated.

The concentration of fluorescein-tagged hyaluronic acid was calculated for each rinse collection sample and lens case soak solution sample by applying the equation generated for the standard curve linear regression using the known fluorescence intensity for the sample and multiplying by the appropriate dilution factor, if necessary.

The amount of fluorescein-tagged hyaluronic acid (in μg) was calculated for each rinse collection sample and lens case soak solution sample by multiplying the concentration of the sample (in ppm) by the volume of the sample (in ml).

The initial amount of fluorescein-tagged hyaluronic acid (in μg) was calculated as the difference between the amount of tagged hyaluronic acid in the solution and the amount of tagged hyaluronic acid in the lens case control soak solution. The lens case control accounts for the amount of tagged hyaluronic acid that binds to the plastic lens case.

The percentage of fluorescein-tagged hyaluronic acid (HA) remaining with each lens was calculated using the following equation:

% of attached tagged HA=100*(initial μg HA on lens−total μg HA released from lens)/initial μg HA on lens

These values are reported in Table 9 and plotted in FIG. 4. Table 9 does not include the data for the seven and eleven hour time point so that the Table can legibly fit on the page. These time points are however included in the plots. Accordingly, FIG. 4 shows the average percentage of fluorescein-tagged HA remaining with each lens type tested as the HBSS is dripped onto the surface of the lens. Table 9 contains the amount, in micrograms, of fluorescein-tagged HA remaining with each lens type tested.

TABLE 9

| Lens Type | Initial | 1 hr | 2 hr | 3 hr | 4 hr | 5 hr |
|---|---|---|---|---|---|---|
| Soflens 38 | 16.48 ± 1.45 | 13.20 ± 0.10 | 11.97 ± 0.14 | 10.97 ± 0.15 | 10.26 ± 0.20 | 9.68 ± 0.22 |
| Acuvue2 | 20.63 ± 2.86 | 17.50 ± 0.44 | 16.44 ± 0.53 | 15.78 ± 0.55 | 15.36 ± 0.63 | 15.00 ± 0.65 |
| Oasys | 17.74 ± 5.02 | 14.86 ± 0.69 | 13.86 ± 1.06 | 13.09 ± 0.95 | 12.56 ± 0.83 | 12.13 ± 0.81 |
| Advance | 17.31 ± 4.56 | 13.41 ± 0.58 | 11.84 ± 0.77 | 10.75 ± 0.89 | 10.00 ± 1.02 | 9.43 ± 1.02 |
| Night&Day | 27.78 ± 2.59 | 23.81 ± 1.17 | 22.47 ± 1.12 | 21.84 ± 1.10 | 21.4 ± 1.13 | 21.07 ± 1.19 |
| O2Optix | 28.64 ± 0.51 | 25.34 ± 0.47 | 24.20 ± 0.57 | 23.47 ± 0.62 | 23.02 ± 0.68 | 22.65 ± 0.70 |
| Biofinity | 17.92 ± 3.85 | 12.37 ± 0.63 | 10.05 ± 0.74 | 8.42 ± 0.81 | 7.12 ± 0.82 | 6.11 ± 0.82 |
| | Lens Type | 6 hr | 8 hr | 9 hr | 10 hr | 12 hr |
| | Soflens 38 | 9.23 ± 0.18 | 8.45 ± 0.16 | 8.17 ± 0.15 | 7.91 ± 0.10 | 7.46 ± 0.11 |
| | Acuvue2 | 14.73 ± 0.67 | 14.26 ± 0.67 | 14.06 ± 0.69 | 13.90 ± 0.69 | 13.65 ± 0.70 |
| | Oasys | 11.78 ± 0.85 | 11.24 ± 0.80 | 10.97 ± 0.72 | 10.79 ± 0.66 | 10.49 ± 0.57 |
| | Advance | 8.98 ± 1.01 | 8.32 ± 0.96 | 8.05 ± 0.89 | 7.80 ± 0.83 | 7.39 ± 0.67 |
| | Night&Day | 20.80 ± 1.20 | 20.41 ± 1.25 | 20.25 ± 1.23 | 20.03 ± 1.22 | 19.77 ± 1.19 |
| | O2Optix | 22.35 ± 0.73 | 21.97 ± 0.74 | 21.76 ± 0.74 | 21.60 ± 0.76 | 21.34 ± 0.80 |
| | Biofinity | 5.34 ± 0.82 | 4.21 ± 0.86 | 3.81 ± 0.82 | 3.48 ± 0.80 | 2.96 ± 0.75 |

The retention and release of hyaluronic acid from the surface of both traditional and silicon hydrogel contact lenses is demonstrated by the detection of fluorescein-tagged hyaluronic acid over a twelve hour period. The ability of the lenses to retain hyaluronic acid on the surface is believed to depend upon the strength of interactive forces (hydrogen bonding, dispersion forces, or dipole-dipole intermolecular interactions) between the hyaluronic acid and the surface chemistry of each lens type.

Interestingly, certain lens material types show a more pronounced effect at maintaining hyaluronic acid on the surface of the lens than others. As demonstrated by the date of Table 9 and the plot of FIG. 4, the release rates of hyaluronic acid from the lens surface varied between lens types with lotrafilcon A, lotrafilcon B, etafilcon A, and senofilcon A exhibiting the slowest rate of release with more than 50% of the hyaluronic acid remaining on the lenses after 12 hours. The lens materials lotrafilcon A (Night&Day®) and lotrafilcon B (020ptix®) show the greatest propensity to maintain hyaluronic acid on the surface. The lens materials etafilcon A (Acuvue2®) and senofilcon (Oasys®) also exhibit a very similar affinity for hyaluronic acid.

Accordingly, by soaking the contact lens in the lens care solution of Example 1(Table 6) for at least two hours, an initial amount of hyaluronic acid to shown to adhere to the contact lens. The hyaluronic acid is then released from the lens over several hours to provide an amount of hyaluronic acid retained on the lens. As described the initial amount of hyaluronic acid and the retained amount of hyaluronic acid retained on the lens is determined by the saline drip study just described. Ideally, the amount of retained hyaluronic acid on the lens after ten hours is from 30% to 85%, or from 45% to 70%, of the initial amount of hyaluronic acid that adhered to the lens. As demonstrated, the amount of retained hyaluronic acid will depend upon the contact lens material, and more importantly, as indicated below with Comparative Example 1 (Table 7), the amount of retained hyaluronic acid will depend on the lens care formulation.

### Retention of Hyaluronic acid for Example 1 vs. Comparative Example 1

### Comparative Example 1

We prepared the lens care solution of Example 5 described in WO 2001057172. The formulation of Comparative Example 1 is provided in Table 7. Comparative Example 1 has a pH of 6.9 and an ionic strength of 0.18M.

A saline drip investigation was conducted as described above using three different contact lens materials; lotrafilcon B (O2Optics), senofilcon A (Oasys) and etafilcon A (Acuvue2). The hyaluronic acid retention plots are provided as FIGS. 5A, 5B and 5C, respectively. As demonstrated, contact lens solutions of similar compositions have a dramatically different surface affinity for hyaluronic acid. For each lens type, the lens care solution of Example 1 maintained greater than 60% of the initial amount of hyaluronic acid adhering to the surface after a 12 hour saline drip. In contrast, Comparative Example 1 lost all or nearly all of the initially attached hyaluronic acid.

TABLE 7

| Comparative Example 1 | wt. % |
|---|---|
| potassium hydrogen phosphate | 0.055 |
| disodium hydrogen phosphate | 0.058 |
| sodium chloride | 0.9 |
| Na₂EDTA | 0.125 |
| Tetronics ® 1107 | 1.0 |
| sodium hyaluronate | 0.02 |
| PAPB (ppm) | 1.0 |

We claim:

1. A method for improving the retention of hyaluronic acid on a surface of a contact lens, the method comprising:
providing a contact lens care solution comprising;
0.005 wt. % to 0.05 wt. % of hyaluronic acid in a borate containing buffer, and 0.01 wt. % to 1.0 wt. % of an amphoteric surfactant of general formula I 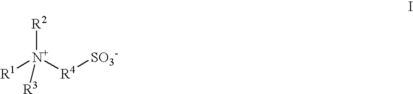
wherein R′ is a C₈-C₁₆alkyl optionally substituted with hydroxyl;
R² and R³ are each independently selected from methyl, ethyl, propyl or iso-propyl; and R⁴ is a C₂-C₈alkylene optionally substituted with hydroxyl; and
soaking the contact lens in the contact lens care solution for at least two hours prior to placement of the contact lens in an eye.

2. The method of claim 1 wherein R² and R³ are each methyl; and R⁴ is a C₂-C₄alkylene.

3. The method of claims 1 wherein the hyaluronic acid is present in the contact lens care solution at a concentration of from 0.005 wt. % to 0.02 wt. %.

4. The method of claim 1 wherein the contact lens care solution further comprises 0.5 ppm to 3 ppm of α-[4-tris(2-hydroxyethyl)-ammonium chloride-2-butenyl]poly[1-dimethyl ammonium chloride-2-butenyl]-ω-tris(2-hydroxyethyl) ammonium chloride, 0.8 ppm to 1.6 ppm of poly(hexamethylene biguanide) or any mixture thereof.

5. The method of claim 1 wherein the contact lens care solution further comprises dexpanthenol, sorbitol, glycolic acid, 2-amino-2-methyl-1,3-propanediol or any mixture thereof.

6. The method of claim 1 wherein the contact lens care solution further comprises propylene glycol, hydroxypropyl guar, hydroxypropylmethyl cellulose or any mixture thereof.

7. The method of claim 1 wherein the contact lens care solution has an ionic strength from 0.05M to 0.16M.

8. The method of claim 1 wherein the contact lens care solution has a pH from 7.2 to 7.5.

9. The method of claim 3 further comprising inserting the contact lens into the eye without rinsing the lens after soaking.

10. The method of claim 1 wherein the soaking of the contact lens with the contact lens care solution provides an initial amount of hyaluronic acid to adhere to the surface of the contact lens, which is then released from the lens over several hours to provide an amount of hyaluronic acid retained on the lens as determined by a saline drip study, wherein the retained hyaluronic acid after ten hours is from 30% to 85% of the initial amount of hyaluronic acid that adhered to the lens.

11. The method of claim 10 wherein the retained hyaluronic acid is from 45% to 70% of the initial amount of hyaluronic acid that adhered to the lens.

12. The method of claim 10 wherein the contact lens is defined by a contact lens material selected from the group consisting of lotrafilcon A, lotrafilcon B, etafilcon A and senofilcon A.
